(19) United States
(12) Patent Application Publication
(10) Pub. No.: US 2008/0110428 A1
(43) Pub. Date: May 15, 2008

(54) Intensity magnetic field axle-free turbo fuel saver

(76) Inventor: Yixin Guo, Ronkonkoma, NY (US)

Correspondence Address: Yixin Guo, 256 Holbrook Ave., Ronkonkoma, NY, 11779, US

(21) Appl. No.: 11/702,232

(22) Filed: Feb. 5, 2007

Related U.S. Application Data
(60) Provisional application No. 60/861,542, filed on Nov. 30, 2006.

(30) Foreign Application Priority Data
Nov. 14, 2006 (CN) 200620125284.8

(51) Int. Cl. F02B 75/12

(52) U.S. Cl. 123/1 R

(57) ABSTRACT

The invention provides the Intensity Magnetic Field Axle-Free Turbo Fuel Saver, it comprising : plastic bearing, bearing sleeves, Axle-free turbine and a cross-shaped high intensity magnetic filed internally round-shaped shaft. It is installed in the air blowing rubber hose of the motor consuming gasoline or diesel. It sends air into the cylinders of the motor, utilizing high intensity magnetization and utilizing the strong circular movement of the air and air pressure coming from the high speed spinning of the axle-free turbine. This can increase the burning speed, cleanness and the completeness of the gasoline or diesel so that oil saving and output power increasing effect is achieved. It applies to any type of cars, trucks and any motor-driven vehicles using gasoline or diesel.

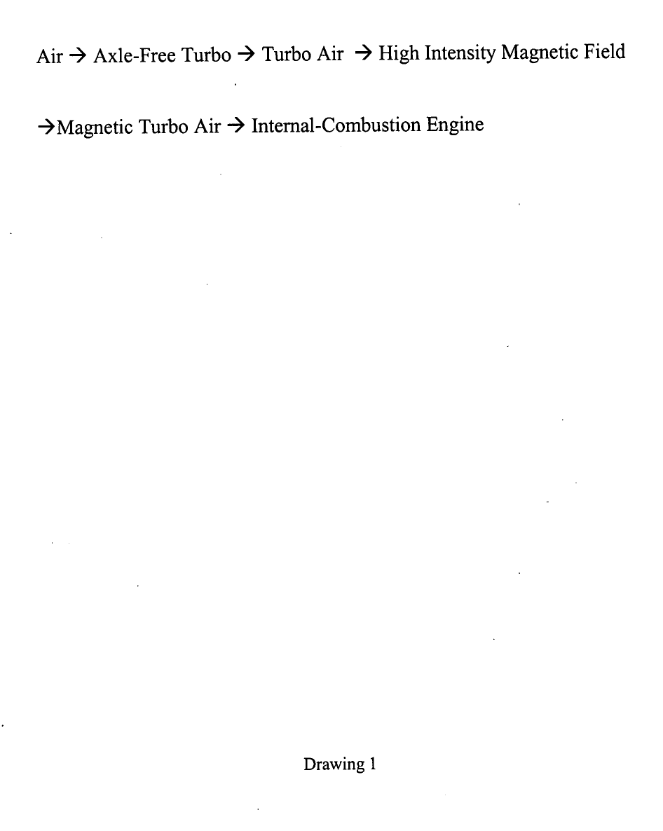

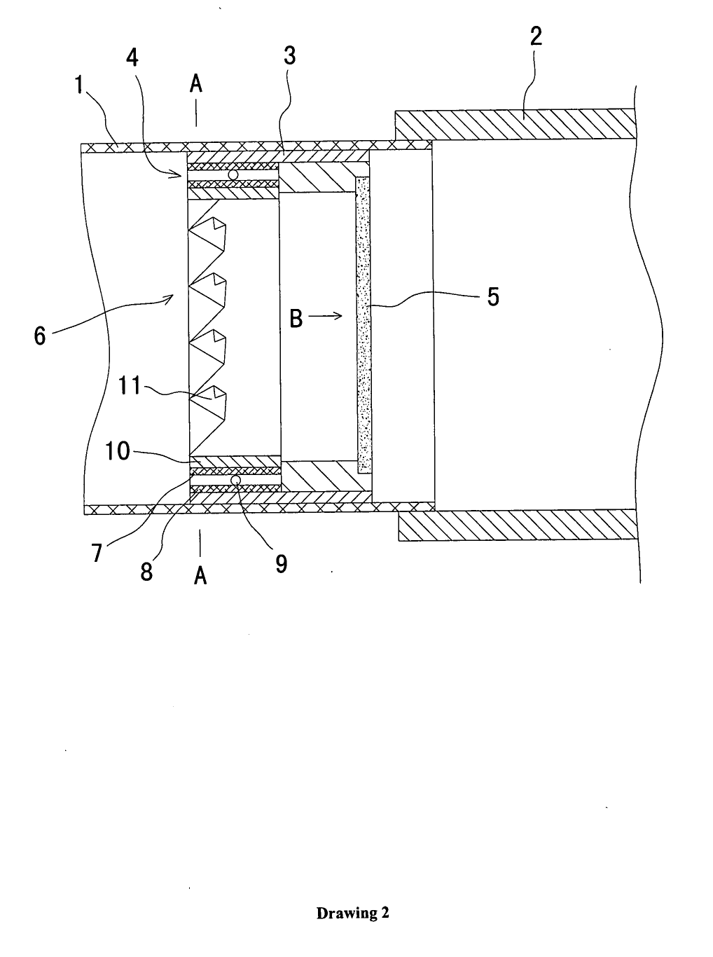

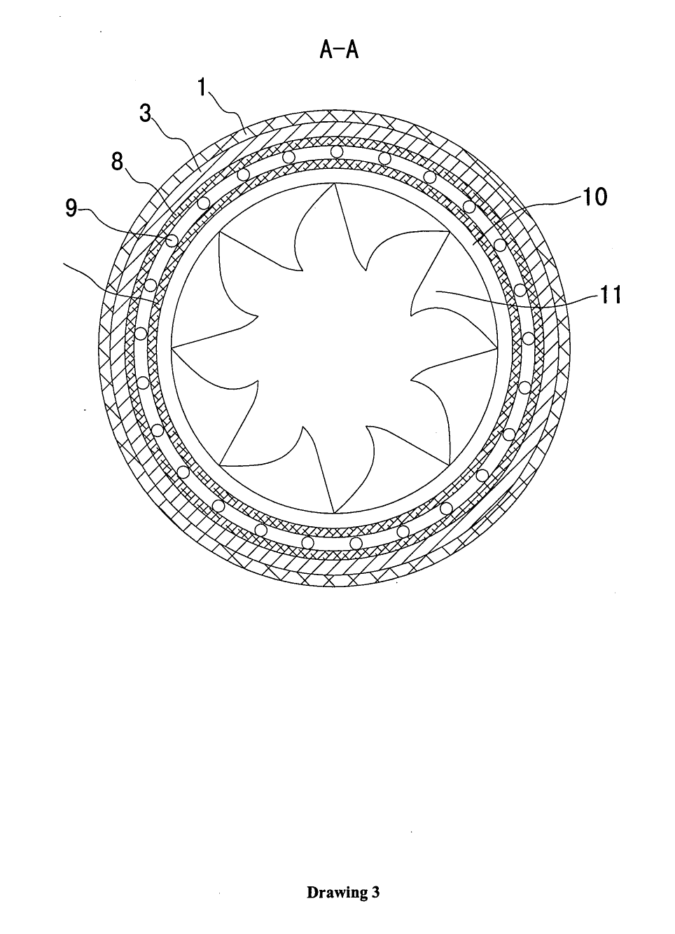

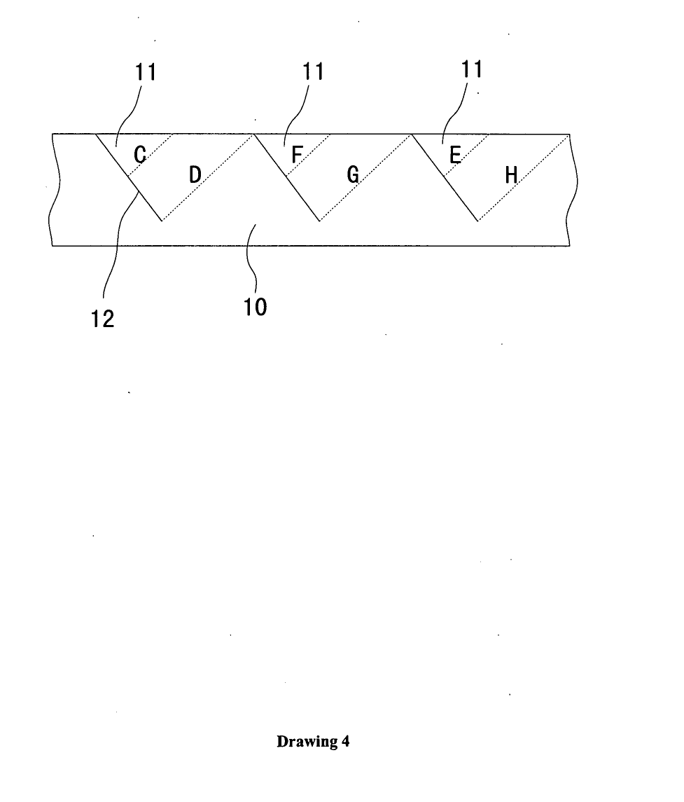

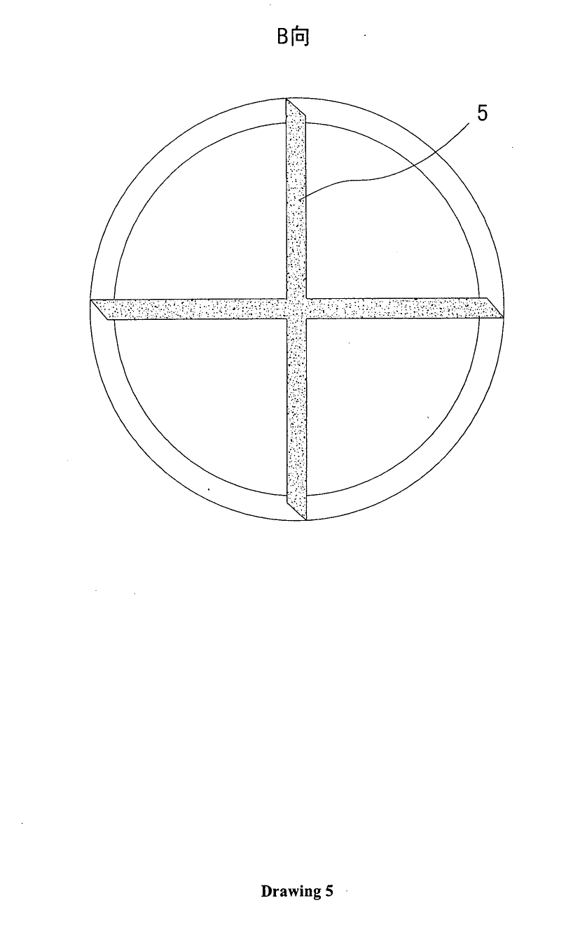

### FIELD OF THE INVENTION

The invention provides a fuel saver used in an internal-combustion engine. The fuel saver is suitable for internal-combustion engine, like the engines of motor-driven vehicles using either gasoline or diesel. The invention uses the high intensity magnetic field to magnetize the air in oil cylinders of the engine and utilize the strong circulation of the air coming from the high speed spinning of the axle-free turbine to increase pressure so that the air can be blown into the cylinder in a circular movement. This can expedite the completeness of the gasoline or diesel burning and increase the efficacy of gasoline or diesel to achieve the objective of saving fuel.

### BACKGROUND OF THE INVENTION

The most similar fuel savers are installed in the air hose of an internal-combustion engine and utilize “the increase-pressure by turbo principle” to increase the air pressure in the air intake nozzle. This can expedite the burning speed of gasoline or diesel in order to achieve the efficacy of gasoline or diesel utilization. But as for existing turbo fuel savers, axle and a bearing are installed in the central section of the air hose to support the turbo. Because there is no power source in the turbo itself and the installation of a bearing, a bearing shaft and the turbo, the air resistance is considerably increased in the air hose, and the air quality is directly affected while the motor vehicle is being ignited. The burning efficacy of the fuel is reduced accordingly. Furthermore, design of the existing turbo fuel savers only take the effect of turbo air pressure increasing to internal-combustion engine into consideration, but the consideration of oil saving by magnetization of air intake was left out. Therefore the actual efficacy is still limited.

### SUMMARY OF THE INVENTION

The invention provides a high intensity magnetic field Axle-free turbo fuel saver. The method comprising: with combination of modification on existing turbo fuel savers and magnetic air intake technology, to design a more efficient fuel saver capable of improving the completeness of fuel burning and make full use of fuel efficacy. A high intensity magnetic field axle-free turbo fuel saver and a high intensity magnetic field magnetizer are installed one after the other in the air hose behind the oil filter of the engine using either gasoline or diesel. The axle-free turbo fuel saver mainly consists of a bearing and an Axle-free turbo. The axle-free turbo consists of a pipe-like rim with a group of vanes on the circular edge of the inner brink. The bearing has an inner and an outer rim. The outer brink of the Axle-free turbo pipe-like rim is fixed on the inner brink of the bearing's inner rim. The outer brink of the bearing's outer rim is fixed on the inner wall of the Air hose. The high intensity magnetic field magnetizer consists of a permanent magnet.

### Explanation of above Technical Proposal:

1. In above proposal, the Turbo fuel saver has a fixed cushion. The Axle-free turbo pressure-increasing device and the High intensity magnetic field magnetizer are installed one after the other in the fixed cushion. The fixed cushion is fixed in the Air hose. The Air hose is made of rubber; the outer brink of the fixed cushion is matched with the inner diameter of the rubber air pipe.

2. In above proposal, the simplest design can be applied: a cylinder is used as the rim. At the circular edge of one end of the cylinder there are at least several oblique cuts with equal distance between them. The cuts are bending toward the internal direction and are formed into vanes. In order to achieve the best performance the axle-turbo should be made of non-magnetic conduction materials to, like plastics. The purpose of using non-magnetic conduction materials is to avoid interaction between the turbo and the permanent magnet, which can decrease the pressure-increasing effect of the Axle-free Turbo Fuel Saver.

3. In above proposal, Following two structures of the permanent magnet can be used:
(1) The permanent magnet is designed as cross-shaped or cylinder. The cross-shaped or cylinder permanent magnet is fixed on the cross section of the air-intake pipe.
(2) The permanent magnet is designed as a group of magnets and the group of magnets are fixed on the internal wall of the air-intake pipe

4. In above proposal, the permanent magnet should be of high magnetic-induction quality:

In brief, this proposal is to utilize the combination of turbo pressure-increasing and magnetic air intaking technology to process the air in the air hose. Among them, magnetic air intaking is to use the High Intensity Magnetic Field to magnetize the air in the engine cylinders and arrange the oxygen molecule orderly after atomizing the fuel rapidly, and make the fuel and the air sufficiently blending in order to improve the burning efficiency, reduce the accumulated carbon in the cylinder and purify the air. Turbo pressure increasing is to use the airflow as power source generated while engine air intaking occurs, and use the strong circulation of the air coming from the high speed spinning of the axle-free turbine and the air pressure to make the air blows into the cylinders in a highly efficient circulation state to expedite the burning speed of gasoline or diesel and increase the completeness of the gasoline or diesel burning. This proposal is suitable for any motor-driven vehicles, including trucks and any motors consuming gasoline or diesel. Its innovation is: With the combination of axle-free turbine and the air atomized by high intensity magnetic field to improve the output power of internal-combustion engines in order to achieve the fuel-saving objective.

### Advantages of the Invention Described in this Proposal:

1. The invention provides axle-free turbine. Its air resistance is greatly reduced during its high speed spinning compared with axle turbine. It does not only improve the pressure increasing effect of the turbine but also improves the pressure increasing efficacy of the turbine.

2. The invention provides the air atomized by high intensity magnetic field and blows into the cylinder, it has a better efficacy and effect compared with the pressure-increasing method using only air circulation.

3. The invention is a new type and high efficacy fuel saver. Its widely introduction and utilization will serve the fast growing motor vehicle energy saving industry.

### BRIEF DESCRIPTION OF THE DRAWING

Drawing 1: The principle of the new and practical technology

Drawing 2: Sectional Drawing of the working state of air hose

Drawing 3: Sectional Drawing of A-A of Drawing 2

Drawing 4: Sketch map of the axle-free turbine vanes bending cuts

Drawing 5: B direction drawing of Drawing 2. It indicates the high intensity magnetic field cross.

In above drawings: 1. Air hose; 2. Nozzle of the cylinders; 3. Fixed cushion; 4, Plastic bearing; 5. The high magnetic field cross; 6. Axle-free turbine; 7. Inner rim; 8. Outer rim; 9. Ball; 10. Cylinder-shaped drum; 11. Vanes; 12. Cuts.

### DETAIL DESCRIPTION OF THE INVENTION

As illustrated in drawing 2, the actual condition of a high intensity magnetic field axle-free turbo fuel saver mounted in the Air hose. In the sketch, first install the high intensity magnetic field axle-free turbo fuel saver inside the end of the air hose 1, then insert the air hose 1 into the end of the cylinder 2. The installation of the axle-free turbo and the installation of the high intensity magnetic field magnetizer are finalized by the fix cushion 3. The axle-free turbo consists of a plastic bearing 4 and axle-free turbo 6. As illustrated in drawing 3, the plastic bearing consists of inner rim 7, outer rim 8 and ball 9. The rim of the axle-free turbo 10 is a plastic cylinder. There are eight oblique cuts on the circular edge of the cylinder. Each cut is bending inwardly and forms the vanes of the turbo 11. As illustrated in drawing 4, sketch map of the axle-free turbine vanes bending cuts 12, the cuts: C, D, E, F, G, H separately indicating the bending line of the vanes 11. While it is being assembled, the outer brink of rim 10 of the axle-free turbo 6 is fixed on the inner brink of the inner rim 7 of the plastic a bearing 4. The outer brink of the outer rim 8 of the plastic a bearing 4 is fixed on the inner brink of the fixed cushion 3. The outer brink of the fixed cushion 3 is fixed on the wall of the air hose 1 and it is matched with the inner diameter of the air hose 1. The high intensity magnetic field magnetizer consists of the high magnetic field cross 5 or cylinder. As illustrated in drawing 5, the high magnetic field cross 5 is also fixed on the inner brink of the fixed cushion 3 and poisoned on the cross section of the air hose. The permanent magnet should be of high magnetic-induction quality. (The Permanent Magnet can also be designed as a group of magnets. One group of magnets is fixed on the inner brink of the Fixed Cushion 3). And the bearing can use the ball-free new technology bearing.

As illustrated in drawing 1, the blowing power generated from the running engine the air is blown into the turbo. As there is a larger empty space inside the Axle-free turbo 6, powerful circular movement of air and air pressure are created by the high speed spinning air coming from the axle-free turbine 6, at the same time the powerful circulating air is sufficiently atomized through the high magnetic field cross and finally was blown into the engine cylinders, which expedites the burning speed of gasoline or diesel, and increases the completeness of the gasoline or diesel burning. So the output power of internal-combustion engine is increased and the fuel saver objective is achieved.

The above actual examples are to explain the technical concept and uniqueness of the invention. Its purpose is to let people, who are familiar with the technology of this invention, get to know the contents of the invention and materialize this project according to its principle. But they are not allowed to use it to impose restrictions on the scope of its protection. The scope of protection of this invention includes any modification and equivalent alteration as described in the principle of this invention.

1. A High Intensity Magnetic Field Axle-free Turbo Fuel Saver. It comprising: one Axle-free turbo and one high intensity magnetic field magnetizer are installed one after the other in the Air hose behind the oil filter of the engine using either gasoline or diesel. The Axle-free Turbo Fuel Saver mainly consists of a bearing and an Axle-free turbo. The Axle-free turbo consists of a pipe-like rim with a group of vanes on the circular edge of the inner brink. The bearing has an inner and an outer rim. The outer brink of the Axle-free turbo pipe-like rim is fixed on the inner brink of the bearing's inner rim. The outer brink of the bearing's outer rim is fixed on the inner wall of the Air hose. The high intensity magnetic field magnetizer consists of a Permanent Magnet. The magnetic field of the Permanent Magnet is used for the Air hose.

2. As described in claim 1, the Turbo Fuel Saver has a fixed cushion. The Axle-free turbo and the high intensity magnetic field magnetizer are installed one after the other in the fixed cushion. The fixed cushion is fixed in the Air hose.

3. As described in claim 1, the air hose is made of rubber. The outer brink of the fixed cushion is matched with the inner diameter of the rubber air hose.

4. As described in claim 1, the rim of Axle-free turbo is a cylinder. The cuts are bending toward the internal direction and are formed into vanes.

5. As described in claim 1, the Axle-free turbo is made of non-magnetic conduction materials.

6. As described in claim 1, the permanent magnet is designed as cross-shaped or cylinder. The cross-shaped or cylinder permanent magnet is fixed on the cross section of the air hose.

7. As described in claim 1, the permanent magnet is designed as a group of magnets and the group of magnets are installed on the internal wall of the air hose.
